(19) United States
(12) Patent Application Publication
(10) Pub. No.: US 2003/0195853 A1
(43) Pub. Date: Oct. 16, 2003

(54) Interaction system and method

(76) Inventor: Cyndi L. Mitchell, London (GB)

Correspondence Address: HOGAN & HARTSON LLP, ONE TABOR CENTER, SUITE 1500, 1200 SEVENTEEN ST., DENVER, CO, 80202, US

(21) Appl. No.: 10/107,276

(22) Filed: Mar. 25, 2002

(51) Int. Cl. G06F 17/60

(52) U.S. Cl. 705/51

(57) ABSTRACT

In preferred embodiments, a system is provided that enables users to choose from a range of interaction mechanisms as they interact both with the system and with other users of the system. The complexity of the mechanisms may vary significantly (e.g., e-mail, threaded discussions, webcasts, etc.). The system is preferably flexible and adaptable, so that, among other things, over the course of time new mechanisms can be introduced.

### FIELD OF THE INVENTION

The preferred embodiments of the present invention relate to the management of interactions between multiple entities. In some illustrative embodiments, interactions are managed via an online interaction system presenting users with a plurality of different interaction mechanisms, such as some examples, webcasts, e-mail, discussion boards, chat-rooms, video conferencing and more.

### BACKGROUND OF THE INVENTION

Following the advent of widely used public and other computer networks such as the Internet, the world wide web, various wide area networks and the like, a variety of forms of electronic and other communication and interaction means have been introduced into societies across the globe. Various new methods of communication and interaction include e-mail, webcasts, chat-rooms, threaded discussion boards, video conferencing and more.

With the rapid emergence of new e-businesses and informational and other web sites, a wide range of electronic communication and interaction mechanisms have been implemented in many contexts, such as in business-to-business websites, consumer-to-business websites and assorted other web applications. Despite the existence of and wide use of numerous communication and interaction mechanisms, there remains a need for new communication and interaction systems and methods improving upon the present state of the art and limitations therein.

### SUMMARY OF THE PREFERRED EMBODIMENTS

In preferred embodiments, a system is provided that enables users to choose from a range of interaction mechanisms as they interact both with the system and with other users of the system. The complexity of the mechanisms may vary significantly (e.g., e-mail, threaded discussions, webcasts, etc.). The system is preferably flexible and adaptable, so that, among other things, over the course of time, new mechanisms can be introduced.

According to some illustrative embodiments of the invention, an online interaction system includes: means for selecting at least one mechanism of communication from a plurality of mechanisms of communication for a first set of system users; means for selecting at least one mechanism of communication from said plurality of mechanisms of communication for a second set of system users; permissioning means for limiting at least some interactions of said first set of system users to users within the first set of users; and permissioning means for limiting at least some interactions of said second set of system users to users within the second set of users. Preferably, means are provided for enabling users from the first and/or second set of system users to select from a plurality of mechanisms of communication for a given interaction. Preferably, record history means are also provided for tracking and/or chasing user communications to provide a record and/or history of such communications.

According to other illustrative embodiments, a method for managing online interaction via an electronic computer system includes: selecting by an administrator at least one mechanism of communication from a plurality of mechanisms of communication for a first set of system users; selecting by another administrator at least one mechanism of communication from said plurality of mechanisms of communication for a second set of system users; limiting at least some interactions of said first set of system users to users within the first set of users based on user permissioning; and limiting at least some interactions of said second set of system users to users within the second set of users based on user permissioning.

Preferred embodiments provide a generic and reusable interaction model that can be employed in substantially any functional model. The actual functional requirements of a system (i.e., the business case for the system) employing interaction model features according to preferred embodiments of the invention can vary based on circumstances.

The preferred embodiments of the invention are based on a software model, which generically documents simple and complex interaction mechanisms between the user and a system and among the users of a system. The model can be plugged into any functional or logical software model in order to capture, and realize, the various interaction and collaborative requirements of a system.

The model is preferably used to create a generic collaboration/interaction framework, which can then be used to plug-in various mechanisms of collaboration (e.g., webcasts, simulations, etc.). Preferably, these can be plugged-in over time with little disruption to an existing system. Among other things, this allows the implementor to wait until the technology, bandwith, etc., mature to the extent that the experience is more likely to be pleasant for the user. Various embodiments, aspects, advantages and/or benefits of various embodiments of the present invention will be appreciated based on the present disclosure. It is contemplated that various embodiments will include and/or exclude different aspects, advantages and/or benefits and that descriptions of aspects, advantages and/or benefits of the various embodiments should not be construed as limiting other embodiments nor the inventions claimed.

### BRIEF DESCRIPTION OF THE DRAWINGS

The attached figures are shown by way of example and not limitation, in which:

FIG. 1 is a schematic diagram showing an interaction domain model according to some embodiments of the invention;

FIG. 2 is a schematic diagram showing an interaction mechanism domain model according to some embodiments of the invention;

FIG. 3 is a schematic diagram showing a learning programme (i.e., program) domain model according to an illustrative environment in which embodiments of the present invention may be employed;

FIG. 4 is a schematic block diagram of an interaction portal system according to some basic embodiments of the invention;

FIG. 5 is a schematic diagram of an illustrative computer network system within which illustrative embodiments of the invention may be implemented;

FIG. 6 is a schematic diagram illustrating a participant's interaction with an e-University or the like in some illustrative and non-limiting embodiments of the invention;

FIG. 7 is a schematic diagram illustrating a participant's interaction via threaded discussion in an e-University or the like in some illustrative and non-limiting embodiments of the invention;

FIG. 8 is a schematic diagram illustrating a participant's scheduling of an interaction with an e-University or the like in some illustrative and non-limiting embodiments of the invention;

FIG. 9A is a schematic diagram illustrating a learn module for an e-University or the like in some illustrative and non-limiting embodiments of the invention, FIG. 9B is a schematic diagram showing the chasing of progress and the collection of metrics in such a module shown in FIG. 9A, and FIG. 9C is a schematic diagram showing the chasing of progress and the collection of metrics in a parallel tutor module for an illustrative and non-limiting e-University or the like environment;

FIG. 10 is a schematic diagram illustrating the preparation of a module specification for an e-University or the like in some illustrative and non-limiting embodiments of the invention; and

FIG. 11A is a schematic diagram of an illustrative system environment in which some illustrative and non-limiting embodiments of the invention may be implemented, and FIG. 11B illustrates applicable protocols employed in some illustrative and non-limiting embodiments of the invention.

### DETAILED DESCRIPTION OF ILLUSTRATIVE PREFERRED EMBODIMENTS

In some illustrative examples, preferred embodiments of the invention can be applied in the context of an online university (i.e., an e-University) or the like environment. For example, an online university or the like may provide instruction and various teaching and/or administrative functions in an online environment over a computer network, such as a public network, like the world wide web or the Internet, a wide area network, a virtual private network and/or any other network of computers. However, various other embodiments may be applied into any environment which, like an electronic university or the like, supports interactions between a plurality of entities.

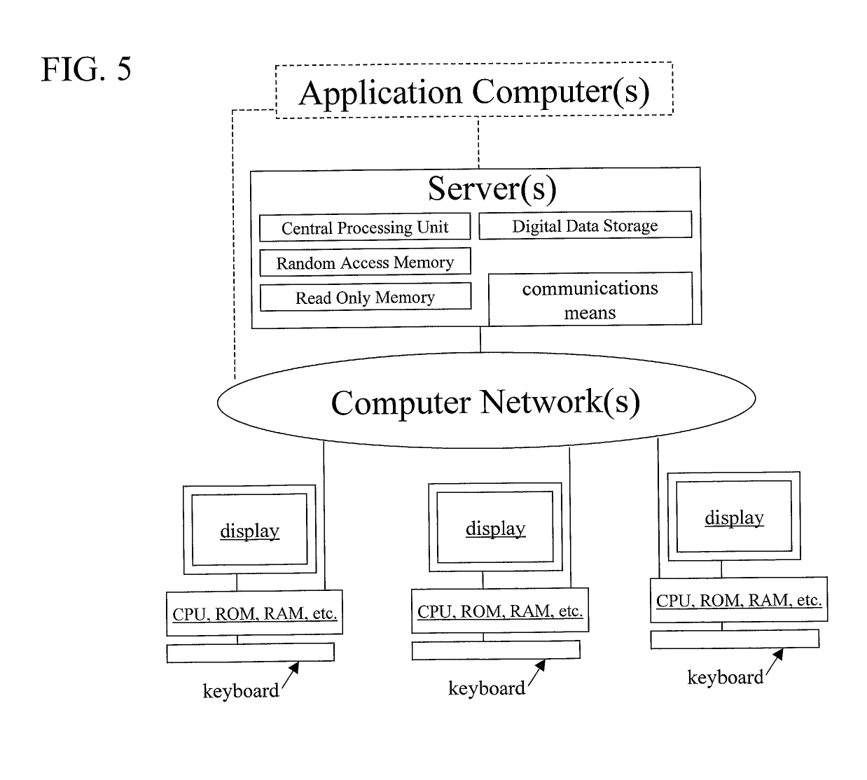

Illustrative embodiments of the present invention can be employed using a computer system having one or more computers. FIG. 5 shows one illustrative computer system in which some embodiments of the present invention can be employed, including a computer network (e.g. such as the world wide web, the Internet, a wide area network (WAN), an intranet, a virtual private network (VPN), any other network of computers, a combination of such networks, or the like) having at least one client computer (e.g., a personal computer, lap top computer, personal digital assistant or any other computer device or system) and at least one server for providing information and/or services to the client computers via the network. As shown, at least one application computer can be provided that may perform various tasks and/or processes. The application computer(s), client computers and server(s) can include any appropriate computers. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. The client computers may contain browser software for interacting with the server(s), such as, for example, using hypertext transfer protocol (HTTP) to make requests of the server(s) via the Internet or the like.

In an illustrative example, the system shown in FIG. 5 can be used to create an online user interface, such as a website interface, a graphical user interface or the like that is presented to users at client computers to enable users to interact with the system. While the illustrated embodiment shows a client/server system, various other embodiments can include other arrangements of one or more computer(s).

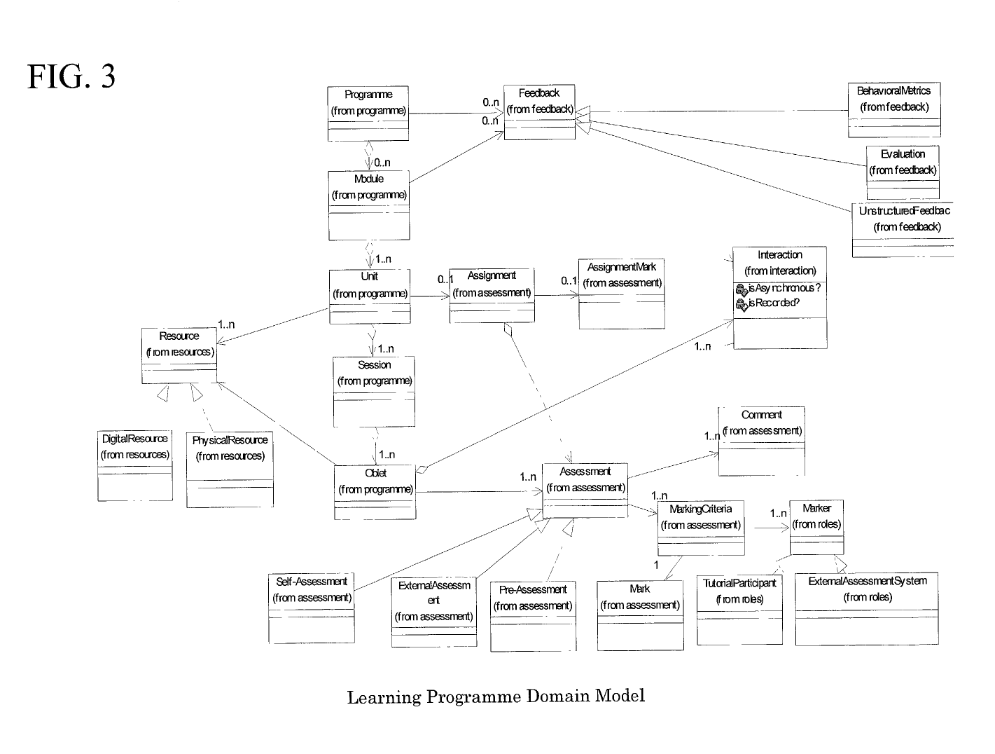

FIG. 3 depicts one illustrative and non-limiting environment in which preferred embodiments of the present invention can be implemented—i.e., in an online university. In this regard, an illustrative electronic university environment is now described. With reference to FIG. 3 (i.e., Learning Program Domain Model Diagram), a highest-level pedagogical entity in the domain model can be called the Program (i.e., Programme), which is represents a program of study for which a degree, certificate, or another award can be granted. The Program can then composed of sub-components, which are organized into a hierarchical tree of Modules, Units, Sessions, and Oblets.

In this illustrative environment, the following axioms can be observed from the current view of the domain model:

The Program sub-components are eventually atomically composed of Oblets, which are the functional aggregation of Interactions that are the learning experience.

The Program sub-components may have one or more supporting Resources associated with them, which supplement the learning experience. These resources may be Physical Resources, such as hardcopies of books or periodicals that are held a library, or Digital Resources, such as websites or external digital libraries that are hosted by institutions or other third parties, and can be referenced from within the e-University portal.

The Program and its sub-components may have one or more instances of Feedback associated with them, which are used to gather and report the opinions of various users regarding the technical and academic quality of the learning experience. Feedback can have, e.g., one or more of three formats: (1) an Evaluation, such as a structured questionnaire, which is presented to one or more users for completion; (2) Unstructured Feedback, such as a spontaneous comment from a user to the e-University or the provider of a program; and/or (3) a collection of Behavioral Metrics, tracking a user's interactions with the system, which can be analyzed to measure and infer the effectiveness of the learning experience.

The Program and its sub-components may have one or more Assignments associated with them, which are used to gauge a user's proficiency in an academic subject. An Assignment is composed of one or more Assessments, of which there are preferably three functional categories: (1) Pre-Assessments, which are used to pre-test a student before she begins learning a module; (2) Self-Assessments, which help the student test her understanding of the subject matter; and/or (3) External Assessments, which are eventually marked and accounted for on the permanent record of the student. Each Assessment can have one or more Marking Criteria, for which a student will be given a Mark, by one or more Markers. A Marker may be either a human being, i.e. a Tutorial Participant, or another computer system.

This illustrative e-University environment requires a complex communication model to enable users to communicate both synchronously and asynchronously with the system, and with other learners, via a variety of mechanisms. Often, a single learning experience will require a hybrid of two or more already complex interaction mechanisms, such as webcasts, chat-rooms, desktop-sharing, threaded-discussions, etc.

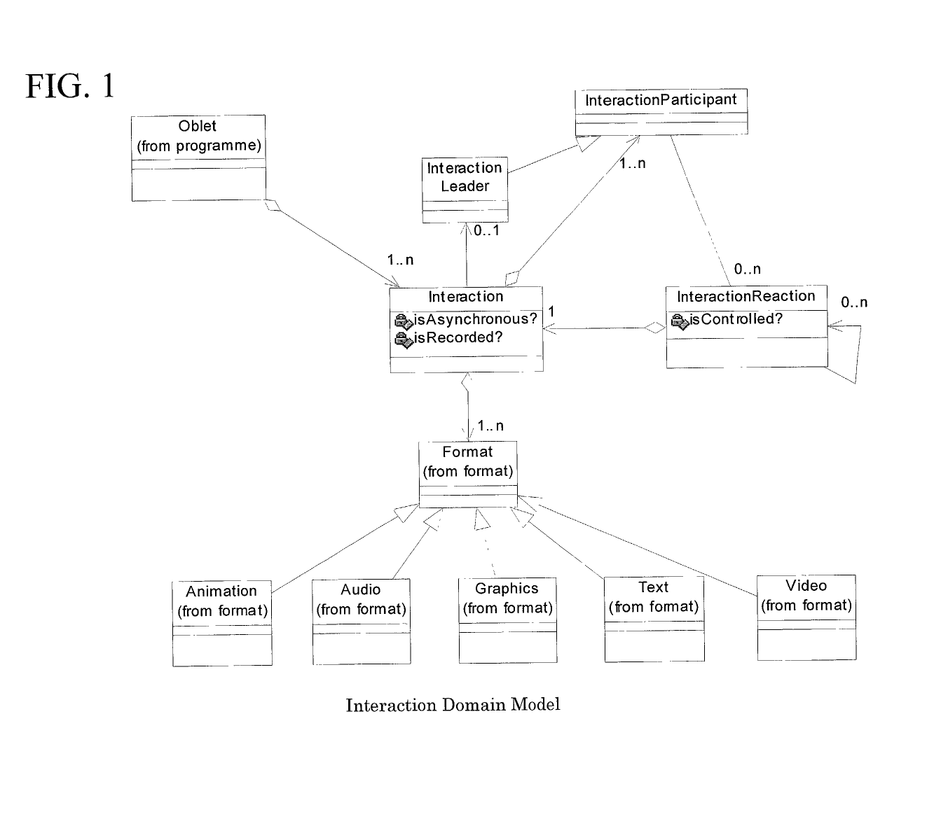

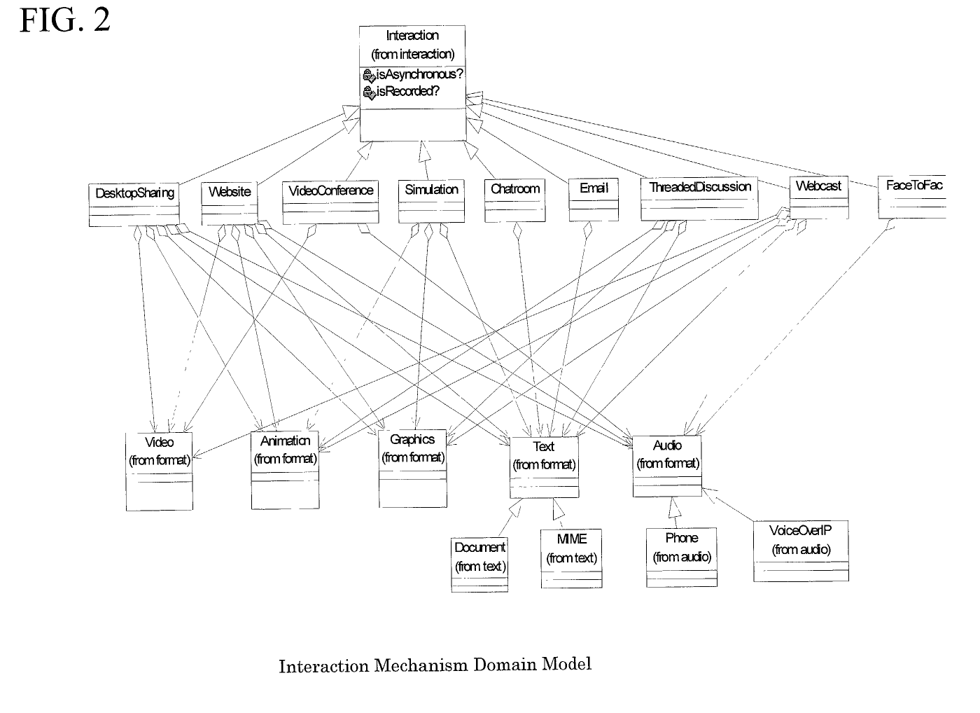

FIG. 1 shows an Interaction Domain Model Diagram that broadly relates to an online university environment as well as numerous other environments, and that can be applied across a wide range of environments. As shown in FIG. 1, an Oblet, the smallest functional atomic unit of, e.g., a learning experience (e.g., in the online university environment), is an aggregation of Interactions. Here, an Interaction is considered to be the aggregation of one or more of the five basic communications formats: Animation, Audio, Graphics, Text, and Video. For instance, as shown in FIG. 2, Interactions using desktop sharing, website, videoconferencing, simulation, chatroom, e-mail, threaded discussion, webcast, face-to-face and/or other interaction mechanisms, can each be considered to aggregations of one or more of these five basic communications formats. Each Interaction can have one or more Interaction Participants, and one of those participants may be designated as the Interaction Leader. In most cases, a participant is allowed to express her response to an Interaction, via an Interaction Reaction.

Some illustrative-concrete-interactions mechanisms through which the Interaction model can be realized are shown in FIG. 2 (Interaction Mechanism Domain Model diagram). In preferred embodiments of the invention, a generic model for the various interaction mechanisms is developed that cogently manages and maintains these concepts.

Illustrative Interaction Portal

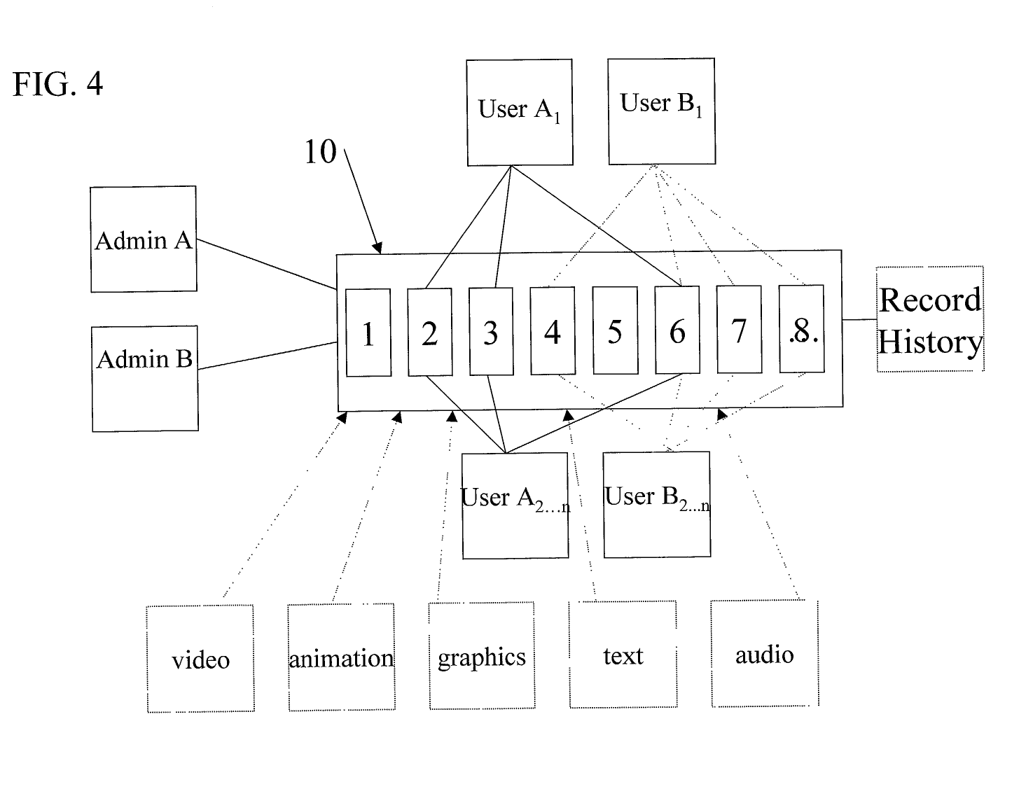

FIG. 4 schematically illustrates an interaction portal 10 according to some illustrative general embodiments. The portal 10 can be constructed, e.g., based on the domain model of FIG. 2. As shown in FIG. 4, the portal preferably supports a plurality of mechanisms of communication or interaction (e.g., with eight mechanisms 1-8 illustrated in one non-limiting example). These mechanisms of communication or interaction can include any mechanism(s) described in the present disclosure, apparent based on this disclosure, currently known, or later developed.

In the illustrative embodiment shown in FIG. 4, the portal may be utilised for a plurality of substantially disjoint groups (i.e., a group pertaining to Interaction A and a group pertaining to Interaction B). In preferred embodiments, the portal is configured such that: a) at least one administrator Admin A can select which of the means of communication 1-8 will be available to users or participants in Interaction A; and b) at least one administrator Admin B can select which the means of communication 1-8 will be available to users or participants in Interaction B. While two groups A and B are shown, various embodiments can include any number of groups. In the illustrated, non-limiting, embodiment, users A₁₋ₙ are enabled to use means 2, 3 and 6, while users B₁₋ₙ are enabled to use means 4, 6, 7 and 8.

In addition, in some illustrative optional implementations of the embodiment shown in FIG. 4, the system can include means for inputting, storing and/or otherwise obtaining data related to a plurality, and preferably all, of each of the following basic formats: animation; audio; graphics; text; and/or video. And, wherein at least some of the various interaction mechanisms employed include means to receive data from one or more of said plurality of these basic-format means.

In addition, in some illustrative optional implementations of the embodiment shown in FIG. 4, the users A₁₋ₙ and/or B₁₋ₙ can preferably select one or more means from a plurality of means of communication for a given interaction.

In addition, in some illustrative optional implementations of the embodiment shown in FIG. 4, a record history means is preferably provided that tracks and/or chases user communications to provide a record and/or history of such communications for use in business operations or the like.

In various embodiments, the interaction system can be adapted or modified so as to contain various features employed in the various other illustrative embodiments described herein.

Operation In Illustrative e-University Embodiments

1. Interaction with the e-University

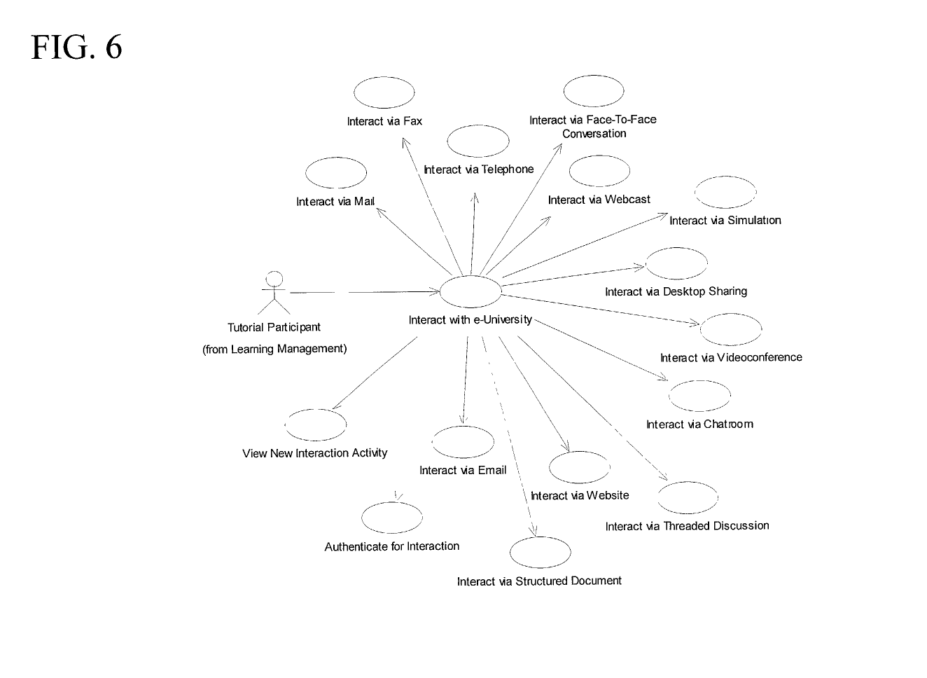

In preferred embodiments, an actor communicates with the e-University and/or other affiliates of the e-University via one or more interaction mechanisms. The interaction may be, e.g., either a reaction to a previous interaction that was initiated by the e-University or another e-University affiliate, or an independent action that is unrelated to any other interactions that are currently in progress. A precondition involves that the actor is logged in to the e-University and has the permissions required to perform the interaction. With reference to FIG. 6, one or more of the following steps can be carried out in illustrative embodiments:

| | |
|---|---|
| 1 | The actor performs a View New Interaction Activity use case, to |
| | review the content of any relevant interaction, which have |
| | occurred but she has not yet seen. |
| 2 | If the actor wishes to initiate an independent action, which is |
| | unrelated to any other interactions that are currently in progress |
| | for e-University, she chooses the interaction mechanism that is |
| | most appropriate for the intended communication. |
| 2.1 | If the previously chosen mechanism requires additional |
| | authentication of the actor, the actor waits while the system |
| | performs an Authenticate for Interaction use case, which |
| | seamlessly authenticates the actor as she begins to |
| | interact. |
| 2.2 | If the chosen mechanism is to send a letter via the postal |
| | service, the actor performs an Interact via Mail use case. |
| 2.3 | If the chosen mechanism is to send a fax, the actor |
| | performs an Interact via Fax use case. |
| 2.4 | If the chosen mechanism is a telephone call, the actor |
| | performs an Interact via Telephone use case. |
| 2.5 | If the chosen mechanism is a face-to-face conversation, the |
| | actor performs an Interact via Face-to-Face Conversation |
| | use case. |
| 2.6 | If the chosen mechanism is a webcast, the actor performs |
| | an Interact via Webcast use case. |
| 2.7 | If the chosen mechanism is a chatroom, the actor performs |
| | an Interact via Chatroom use case. |
| 2.8 | If the chosen mechanism is desktop sharing, the actor |
| | performs an Interact via Desktop Sharing use case. |
| 2.9 | If the chosen mechanism is a simulation, the actor performs |
| | an Interact via Simulation use case. |
| 2.10 | If the chosen mechanism is a videoconference, the actor |
| | performs the Interact via Videoconference use case. |
| 2.11 | If the chosen mechanism is the e-University web site, the |
| | actor performs an Interact via Website use case. |
| 2.12 | If the chosen mechanism is email, the actor performs an |
| | Interact via Email use case. |
| 2.13 | If the chosen mechanism is to upload a structured |
| | document, such as STAROFFICE, MICROSOFT WORD, |
| | etc., the actor performs an Interact via Structured |
| | Document use case. |
| 2.14 | If the chosen mechanism is a threaded discussion, the |
| | actor performs an Interact via Threaded Discussion use |
| | case. |
| 3 | Else if the actor wishes to react to an interaction that has been |
| | initiated by the e-University or one of its affiliates, see paragraph 2 |
| | immediately below. |

2. View New Interaction Activity

In preferred embodiments, an actor views a summary of any interactions that are relevant to her, which have occurred, but she has not yet seen. Preconditions to this include: a) the actor is logged into the e-University portal; and b) the actor has permission to view the new interaction activity. In this regard, one or more of the following steps can be carried out in illustrative embodiments:

| | |
|---|---|
| 1 | The actor navigates via the e-University portal to the location |
| | where she can view the new interaction activity. The new |
| | interactions which have occurred, but not been reviewed by the |
| | actor are displayed as a list of hyperlinks. |
| 2 | If the actor wishes to review the content of any of the listed |
| | interactions, she selects its hyperlink and performs the Interact |
| | with e-University use case as appropriate to view and respond to |
| | the interaction. |

3. Authenticate for Interaction

In preferred embodiments, an actor has just initiated an interaction with the e-University via a mechanism that requires extra authentication (e.g., in addition to what was provided when they originally logged into the portal). The system performs this authentication seamlessly, so that the actor is not aware of it. Preconditions to this include that: the actor is logged into the e-University portal; and the actor has permission to perform the authentication that system will do on her behalf. The system will then authenticate the actor. In this regard, one or more of the following steps can be carried out in illustrative embodiments:

| | |
|---|---|
| 1 | The actor initiates an interaction with the e-University via a |
| | mechanism that requires further authentication. |
| 2 | The system automatically performs the necessary authentication, |
| | without the actor's intervention. |

4. Interact Via Mail

In preferred embodiments, the actor communicates with e-University local partners or other tutorial participants by sending a letter through a postal service. A precondition involves that the actor is logged into the e-University portal. In this regard, one or more of the following steps can be carried out in illustrative embodiments:

| | |
|---|---|
| 1 | The actor uses the e-University portal as necessary to obtain the |
| | address of the intended recipient of the letter that she has |
| | composed, and addresses the letter. |
| 2 | The actor pays the postage costs and mails the letter. |

5. Interact Via Facsimile

In preferred embodiments, the actor communicates with the e-University local partners or other tutorial participants by sending a facsimile. A precondition involves that the actor is logged into the e-University portal. In this regard, one or more of the following steps can be carried out in illustrative embodiments:

| | |
|---|---|
| 1 | The actor uses the e-University portal as necessary to obtain the |
| | fax number of the intended recipient of the letter that she has |
| | composed. |
| 2 | The actor faxes the letter. |

6. Interact Via Telephone

In preferred embodiments, the actor communicates with the e-University local partners or other tutorial participants by telephone. A precondition involves that the actor is logged into the e-University portal. In this regard, one or more of the following steps can be carried out in illustrative embodiments:

| | |
|---|---|
| 1 | The actor uses the e-University portal as necessary to obtain the |
| | telephone number of the individual or group she would like to |
| | contact. |
| 2 | The actor places the telephone call. |

7. Interact Via Face-to-Face Conversation

In preferred embodiments, the actor communicates with the e-University local partners or other tutorial participants via a face-to-face conversation. Preconditions include that: the actor has received an invitation to participate in a face-to-face conversation with others, or the actor has scheduled the conversation via the Schedule Interaction use case, and invited others to participate; and the actor has the necessary permissions to participate. In this regard, one or more of the following steps can be carried out in illustrative embodiments:

| | |
|---|---|
| 1 | The actor goes to the location indicated in the meeting invitation. |
| 2 | The actor participates in the face-to-face forum. The subject |
| | matter and participants will vary greatly depending upon the |
| | purpose of the forum. Some examples may include: (1) a meeting |
| | between a student and a guidance counsellor at an e-University |
| | Local Partner organisation; (2) a study-group meeting between a |
| | several students in a cohort; (3) an open office-hours session |
| | among a tutor and several students; etc. |

8. Interact Via Webcast

In preferred embodiments, the actor communicates with other tutorial participants via a webcast. Preconditions include that: the actor has received an invitation to participate in the webcast or the actor has scheduled the webcast via the Schedule Interaction use case and invited others to participate; the actor has the necessary permissions to participate; and the actor is logged in to the e-University. In this regard, one or more of the following steps can be carried out in illustrative embodiments:

| | |
|---|---|
| 1 | The actor performs an Initialise Desktop use case. |
| 2 | The actor performs a Specify Collaboration Pseudonym use |
| | case. |
| 3 | Once the host, who was designated at the time of scheduling the |
| | webcast, begins leading the participants through the content of |
| | the webcast, the actor engages in the webcast, by viewing and/or |
| | interacting with the content that is cast onto their desktop. |
| 4 | If the webcast has been configured to allow open participation, |
| | the actor may submit her reaction to the webcast events at any |
| | time via an Interact via Simulation use case. |
| 5 | Else the webcast has been configured to allow only controlled |
| | reactions to the webcast events, and the host may decide to |
| | enable and disable reaction capabilities for all or some of the |
| | participants at any point during the webcast. |
| 5.1 | If the host enables reaction capabilities for the actor, she |
| | can react to the webcast events via the Interact via |
| | Simulation use case. |
| 6 | If the host elects to include desktop sharing as a part of the |
| | webcast, the actor performs an Interact via Desktop Sharing use |
| | case. |
| 7 | The actor continues to engage until the webcast is completed. |

9. Interact Via Desktop Sharing

In preferred embodiments, the actor communicates with other tutorial participants via desktop sharing. Preconditions include that: the actor has received an invitation to participate in the desktop sharing event or the actor has scheduled the desktop sharing event via the Schedule Interaction use case and invited others to participate; the actor has the necessary permissions to participate; and the actor is logged in to the e-University. In this regard, one or more of the following steps can be carried out in illustrative embodiments:

| | |
|---|---|
| 1 | The actor performs an Initialise Desktop use case. |
| 2 | The actor performs a Specify Collaboration Pseudonym use case. |
| 3 | Once the host, who was designated at the time of scheduling the |
| | desktop sharing event, selects the application on her desktop that |
| | she wishes to share, the application is projected onto the |
| | desktops of all participants, and the actor views the application on |
| | her own desktop. |
| 4 | The actor looks on while the host uses the application. At any |
| | time, the host may elect to transfer control of the application to |
| | other participants in the desktop sharing event. The participant to |
| | whom control is delegated will then use the application while the |
| | other look on. For example, all participants could jointly create a |
| | spreadsheet by having each actor can take turns entering data |
| | into a projected instance of the MICROSOFT EXCEL application. |
| 5 | If the host elects to transfer control to the actor, the actor uses |
| | the application until the host elects to regain control. |
| 6 | The actor continues to engage until the desktop sharing event is |
| | completed. |

10. Interact Via Simulation

In preferred embodiments, the actor communicates with other tutorial participants via a simulation. Preconditions include that: the actor has received an invitation to participate in the simulation or the actor has scheduled the simulation via the Schedule Interaction use case and invited others to participate; the actor has the necessary permissions to participate; the actor is logged in to the e-University. In this regard, one or more of the following steps can be carried out in illustrative embodiments:

| | |
|---|---|
| 1 | The actor performs an Initialise Desktop use case. |
| 2 | The actor performs a Specify Collaboration Pseudonym use |
| | case. |
| 3 | Once the host begins (designated at the time of scheduling), the |
| | actor engages in the simulation, continuously interacting via a |
| | variety of mechanisms until the simulation ends. Possible |
| | mechanisms may include, but not be limited to: |
| | Verbal communication using voice over IP or standard |
| | phone conferencing, |
| | Written communication using chatroom features that are |
| | hosted within the simulation environment, |
| | Whiteboard-style drawings and animations |
| | Structured animations and graphics which have been pre- |
| | prepared for the simulation |

11. Interact Via Videoconference

In preferred embodiments, the actor communicates with other tutorial participants via videoconference. Preconditions include that: the actor has received an invitation to participate in the videoconference or the actor has scheduled the videoconference via the Schedule Interaction use case and invited others to participate; the actor has the necessary permissions to participate; the actor is has access to a videoconferencing system. In this regard, one or more of the following steps can be carried out in illustrative embodiments:

| | |
|---|---|
| 1 | The actor goes to the location where the videoconferencing |
| | equipment is installed as indicated in the meeting invitation. |
| 2 | The actor participates in the videoconference. The subject matter |
| | and participants will vary greatly depending upon the purpose of |
| | the videoconference. For example, an institution might decide to |
| | host a special guest lecture with a Subject Matter Expert via |
| | videoconference. |

12. Interact Via Chatroom

In preferred embodiments, the actor communicates with other tutorial participants via a synchronous chatroom discussion. Preconditions include that: the actor has received an invitation to participate in the chatroom discussion or the actor has scheduled the chatroom discussion via the Schedule Interaction use case and invited others to participate; the actor has the necessary permissions to participate; the actor is logged in to the e-University. In this regard, one or more of the following steps can be carried out in illustrative embodiments:

| | |
|---|---|
| 1 | The actor uses the e-University portal to navigate to the hyperlink |
| | for the virtual location of the chatroom (a URL), which was |
| | included in the original invitation. |
| 2 | The actor performs a Specify Collaboration Pseudonym use |
| | case. |
| 3 | The actor clicks on the hyperlink, and the chatroom is displayed |
| | within the e-University portal. |
| 4 | The actor engages in the open chatroom dialogue by reading the |
| | text input by other participants, and typing in her own text to |
| | contribute to the discussion. |

13. Interact Via Website

In preferred embodiments, the actor uses a pointer device (e.g., a mouse or the like) and/or an input device (e.g., a keyboard or the like) to navigate the e-University portal and it's hosted learning materials, and views the displayed content. Preconditions include that: the actor has the necessary permissions to browse the material to which she navigates; and the actor is logged in to the e-University. In this regard, one or more of the following steps can be carried out in illustrative embodiments:

| | |
|---|---|
| 1 | The actor uses the mouse and/or keyboard to navigate via the e- |
| | University portal to the material she wishes to view. |
| 2 | The actor reads and/or views the material. |
| 3 | If the material contains hyperlinks to other content which is |
| | interesting or useful to the actor, she will continue to interact via |
| | the website. Go to step 1. |

14. Interact Via Structured Document

In preferred embodiments, the actor creates a structured document using one or more productivity tools, and then uploads that document to the e-University via the portal so that it can be downloaded, viewed and/or modified by other actors. Preconditions include that: the actor has the necessary permissions to upload the document; and the actor is logged in to the e-University. In this regard, one or more of the following steps can be carried out in illustrative embodiments:

| | |
|---|---|
| 1 | The actor creates a document using a productivity tool such as |
| | STAROFFICE, MICROSOFT WORD, MICROSOFT EXCEL, etc. |
| 2 | The actor uploads the document via the e-University portal. |
| 3 | The actor notifies other actors that the document has been |
| | uploaded and waits while other actors download and review the |
| | document. |
| 4 | If another actor chooses to modify the document, she uploads the |
| | modified version via the e-University portal, and notifies the |
| | original actor in this use case. |
| 4.1 | The original actor reviews the modifications, and makes |
| | further changes to the document as necessary. The use |
| | case returns to step 2. |

15. Interact Via E-Mail

In preferred embodiments, the actor composes and sends an e-mail to the e-University and/or one or more affiliates of the e-University. Preconditions include that: the actor has the necessary permissions to send e-mail; and the actor is logged into the e-University. In this regard, one or more of the following steps can be carried out in illustrative embodiments:

| | |
|---|---|
| 1 | The actor uses the e-University portal to compose an email. |
| 2 | The actor enters the intended recipients' email addresses. |
| 3 | The actor sends the email. |

16. Interact Via Threaded Discussion

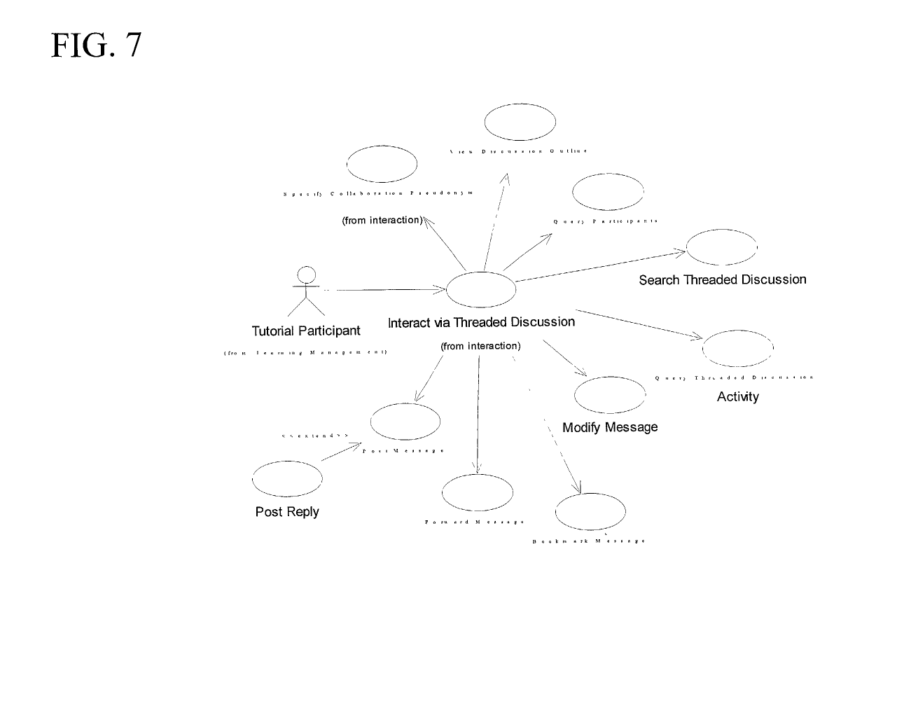

In preferred embodiments, the actor communicates with other tutorial participants via a threaded discussion. Preconditions include that: the threaded discussion has been created according to the Administer Threaded Discussion use case; the actor has the necessary permissions to participate in the threaded discussion; the actor is logged in to the e-University. In this regard, with reference to FIG. 7, one or more of the following steps can be carried out in illustrative embodiments:

| | |
|---|---|
| 1 | The actor navigates via the e-University portal to the location of |
| | the threaded discussion within the e-University portal. |
| 2 | If the actor is entering the threaded discussion forum for the first |
| | time, the actor performs a Specify Collaboration Pseudonym use |
| | case. |
| 3 | The actor performs a View Discussion Outline use case. |
| 4 | If the actor is interested in viewing a list of other participants and |
| | their specific contributions to the threaded discussion, the actor |
| | performs the Query Participants use case. |
| 5 | If the actor wishes to modify a message that they have posted to the |
| | threaded discussion, she performs a Modify Message use case. |
| 6 | If the actor wishes to search for keywords in the threaded |
| | discussion, she performs a Search Threaded Discussion use case. |
| 7 | If the actor wishes to view a history of the activity on the threaded |
| | discussion, she performs a Query Threaded Discussion Activity |
| | use case. |
| 8 | If the actor wishes to bookmark a message in the threaded |
| | discussion, she performs a Bookmark Message use case. |
| 9 | If the actor wishes to forward a message in the threaded |
| | discussion, she performs a Forward Message use case. |
| 10 | If the actor wishes to contribute a new message to the threaded |
| | discussion, she performs a Post Message use case. |
| 11 | If the actor wishes to reply to an existing message in the threaded |
| | discussion, she performs a Post Reply extension of the Post |
| | Message use case. |

17. Query Threaded Discussion Activity

In preferred embodiments, the actor queries across one or more threaded discussions to determine which messages have been read by whom and when. Preconditions preferably include that the actor has the necessary permissions to query the activity of the threaded discussion. In this regard, one or more of the following steps can be carried out in illustrative embodiments:

| | |
|---|---|
| 1 | The actor navigates via the e-University portal to the location of |
| | the threaded discussion activity querying facility. A list of all |
| | modules in which the actor is currently participating is displayed. |
| 2 | The actor selects a module for which she would like to perform |
| | the query, and a list of ALL of the threaded discussions that are |
| | associated with the module is displayed. The list is hierarchically |
| | organised and displayed according to the participant list, which |
| | may include: |
| | The entire cohort for the module; |
| | Only the members of a given tutorial group; and/or |
| | Only the members of a smaller group, which has been set |
| | up within a tutorial group. |
| | Each entry in the list is accompanied by its descriptive details, |
| | which were entered via an Administer Threaded Discussion Use |
| | Case. |
| 3 | The actor selects one or more threaded discussions from the list |
| | to use as the basis for her query. |
| 4 | The actor enters one or more search criteria for the query. Some |
| | examples may include, but not be limited to: an individual's |
| | name, a message subject title, posted on or before date, read |
| | status (Read/Not Read), etc. |
| 5 | The actor submits the query and the matching messages are |
| | returned and displayed within the e-University portal. |
| 6 | If the actor wishes to read any of the messages in the list, she |
| | performs a View Message use case. |

18. Administer Threaded Discussion

In preferred embodiments, the actor performs the tasks necessary to create and maintain a threaded discussion forum. Preconditions include that: the actor has the necessary permissions to administer a threaded discussion forum; the actor is logged into the e-University portal. In this regard, one or more of the following steps can be carried out in illustrative embodiments:

| | |
|---|---|
| 1 | The actor navigates via the e-University portal to the location of |
| | the threaded discussion administration facility. |
| 2 | If the actor wishes to create a new threaded discussion, she |
| | selects the hyperlink that enables the creation of a new threaded |
| | discussion, and a new threaded discussion is enabled. |
| 3 | If the actor wishes to modify the administrative properties of the |
| | threaded discussion, she selects the hyperlink that enables the |
| | modification of a threaded discussion's properties, and is |
| | prompted to modify various items. |
| 3.1 | The actor provides descriptive information about the |
| | thread, e.g. the name of the associated module and |
| | tutorial group, the subject matter, the administrator of the |
| | thread, the name of the discussion leader, etc. |
| 3.2 | The actor specifies the maximum size of the attachments |
| | that may be added to the message. |
| 3.3 | The actor adds/removes one or more individuals to/from |
| | the list of participants who can take part in the threaded |
| | discussion. |
| 3.4 | The actor assigns appropriate permissions to each of the |
| | participants, e.g., read-only. |
| 4 | If the actor wishes to delete any of the messages in the threaded |
| | discussion list, she clicks a hyperlink within the administration |
| | forum that enables the deletion of a specific message in a thread. |
| | The message is deleted. |
| 5 | If the actor wishes to reposition any of the messages in the |
| | threaded discussion list, she clicks a hyperlink within the |
| | administration forum that enables moving a specific message in a |
| | thread, and indicates to which location the message should be |
| | moved. The message is repositioned. |
| 6 | If the actor wishes to spin off a particularly active thread in a |
| | threaded discussion, she clicks a hyperlink within the |
| | administration forum that enables the spawning of a new thread, |
| | using an existing message as its foundation. A new threaded |
| | discussion is spawned, and the properties (permissions, |
| | participants, etc.) from the originating threaded discussion, are |
| | inherited by default. |

19. Juxtapose Threaded Discussion and Learning Material

In preferred embodiments, the actor compares, contrasts and/or contributes to a threaded discussion that is embedded within, and closely related to, the learning material for a specific module. Preconditions may include that: during a Produce Module use case, the program provider has specified and created a module, which contains units and/or sessions, that contain one or more threaded discussions within the learning material; the threaded discussion has been created via an Administrate Threaded Discussion use case; and the actor is logged in to the e-University portal. In this regard, one or more of the following steps can be carried out in illustrative embodiments:

| | |
|---|---|
| 1 | While performing a Learn Module (if actor is a Learner), or a |
| | Tutor Module (if actor is a Tutor) use case, the actor encounters a |
| | threaded discussion that is embedded within the learning |
| | material. The threaded discussion outline is displayed |
| | immediately alongside the learning material within the e- |
| | University portal. |
| 2 | The actor reviews the outline of the threaded discussion, and |
| | reads any messages that are of interest, by performing a View |
| | Discussion Outline use case. As the actor reads the message(s), |
| | she may refer to and/or compare and contrast the discussion with |
| | the related learning material. |
| 3 | If the actor chooses to post a message to the threaded |
| | discussion, she performs a Post Message use case. |

20. Review Threaded Discussion Offline

In preferred embodiments, the actor reads and responds to the messages in a threaded discussion offline in disconnected mode, and later synchronises her work with the e-University. Preconditions may include that: the actor has the necessary permissions to review and respond to a threaded discussion offline; and the actor is logged into the e-University. In this regard, one or more of the following steps can be carried out in illustrative embodiments:

| | |
|---|---|
| 1 | The actor downloads the messages from one or more discussion |
| | threads. |
| 2 | The actor performs an Interact via Threaded Discussion use case |
| | offline; she and reads and composes discussion thread |
| | messages as if she were still connected to the e-University. |
| 3 | When the actor goes back online, she synchronises her offline |
| | threaded discussion activities with the e-University, posting any |
| | messages that she has composed. |

21. Initialize Desktop

In preferred embodiments, the actor performs the steps necessary to enable their desktop environment to participate in a synchronous collaboration such as a webcast, a simulation or desktop sharing. Preconditions may include that: the actor has received an invitation to participate in a synchronous collaboration, or the actor has scheduled a synchronous and invited others to participate; the actor has the necessary permissions to participate; and the actor is logged in to the e-University. In this regard, one or more of the following steps can be carried out in illustrative embodiments:

| | |
|---|---|
| 1 | The actor uses the e-University portal to navigate to the hyperlink |
| | for the virtual location of the synchronous collaboration (a URL), |
| | which was included in the original invitation. |
| 2 | The actor clicks on the hyperlink. |
| 3 | A new browser is launched, and a connection is opened to the |
| | URL that is designated by the hyperlink. |
| 4 | The actor waits while the synchronous collaboration tools check |
| | the actor's desktop to ensure that it supports minimum |
| | requirements for the collaboration environment (bandwidth, |
| | browser version, etc.). |
| 5 | If the system prompts the actor to download and install a software |
| | package that will enable the synchronous collaboration |
| | environment, the actor follows the instructions given until the |
| | installation is complete, and her desktop environment is verified. |
| 6 | If the actor wishes to record the events of the collaboration, so |
| | that can be viewed later she performs a Record Synchronous |
| | Collaboration use case. |

22. Record Synchronous Collaboration

In preferred embodiments, the actor performs the steps necessary to record a synchronous collaboration in which they are planning to participate, such as a webcast, a simulation, or a desktop sharing event. Preconditions preferably include that: the actor has the necessary permissions to participate in and record the collaboration; and the actor is logged into the e-University. In this regard, one or more of the following steps can be carried out in illustrative embodiments:

| | |
|---|---|
| 1 | The actor utilises the features of the software package that |
| | enables the synchronous collaboration environment to indicate |
| | that she wants to record the collaboration event. |
| 2 | The actor participates in the collaboration. |
| 3 | When the collaboration event is completed, the actor again |
| | utilises the software package that enabled the synchronous |
| | collaboration environment to replay the recorded event. |

23. Schedule Interaction

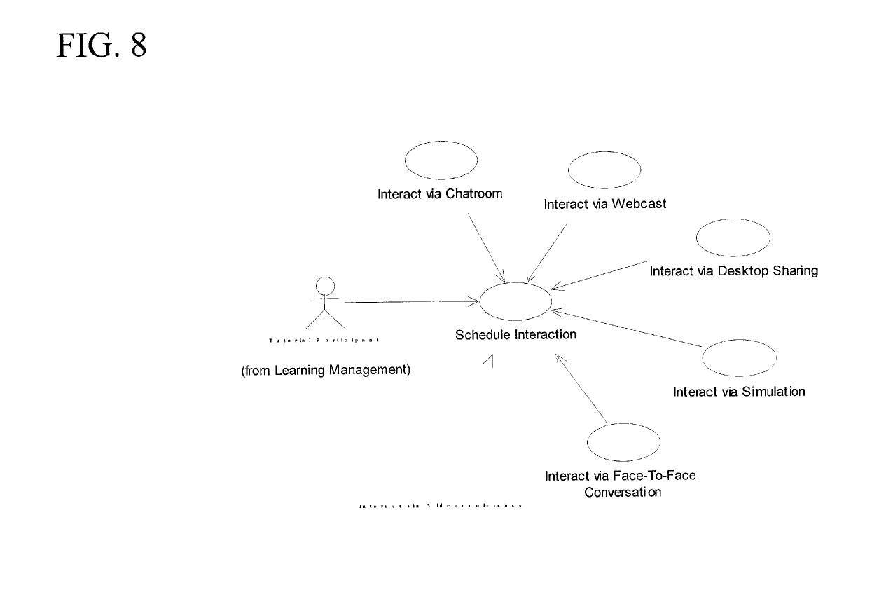

In preferred embodiments, the actor schedules, for example, a webcast, a simulation, a chatroom discussion or a desktop sharing event and sends an invitation to the intended participants. Preconditions preferably include that: the actor has the necessary permissions to schedule the event; and the actor is logged into the e-University. In this regard, with reference to FIG. 8, one or more of the following steps can be carried out in illustrative embodiments:

| | |
|---|---|
| 1 | The actor navigates e-University portal to the location where |
| | synchronous collaborations can be scheduled. |
| 2 | The actor selects the type of collaboration forum she would like to |
| | schedule (webcast, simulation, chatroom discussion, desktop |
| | sharing event, or face-to-face conversation), and enters name of |
| | the host, the time, date and topic for the event. |
| 3 | The actor specifies the participants for the discussion and the |
| | system sends and invitation to all intended participants. |

24. Specify Collaboration Pseudonym

In preferred embodiments, the actor specifies the name they would like to be known while they participate in a synchronous or asynchronous collaboration. Preconditions preferably include that: the actor is preparing to engage in an interaction that requires synchronous or asynchronous collaboration; the actor has the necessary permissions to specify collaboration pseudonym; the actor is logged into the e-University. In this regard, one or more of the following steps can be carried out in illustrative embodiments:

| | |
|---|---|
| 1 | The actor has navigated via the e-University portal to the location |
| | in which a synchronous or asynchronous collaboration will occur. |
| | Before engaging in the collaboration, she is prompted to specify |
| | how she would like to be known to the other participants. She |
| | selects one two options: |
| | Participate using a pseudonym for herself; |
| | Participate using her name as it is registered to the e- |
| | University |
| 2 | If the actor chooses to participate using a pseudonym, she enters |
| | the name by which she would like to be known throughout the |
| | duration of the collaboration. |

25. Learn Module

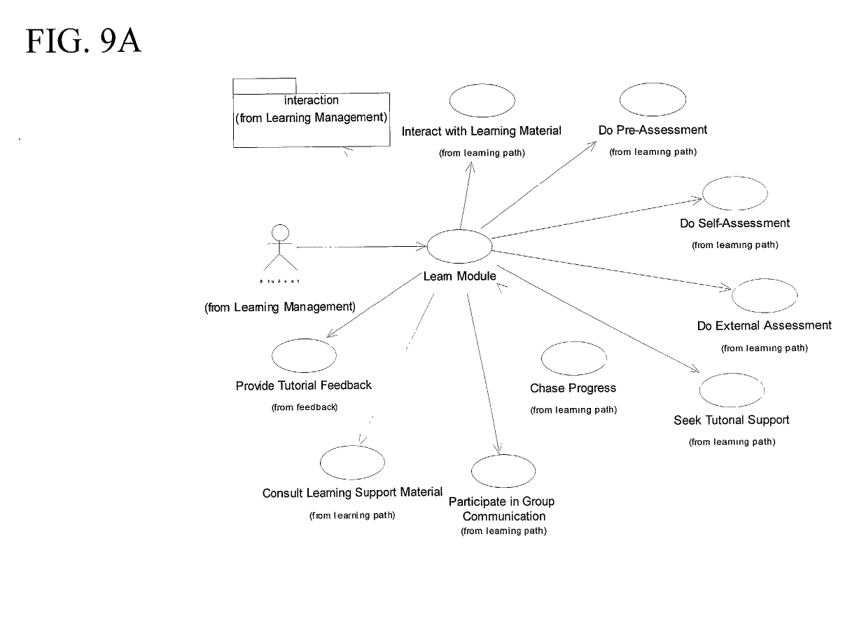

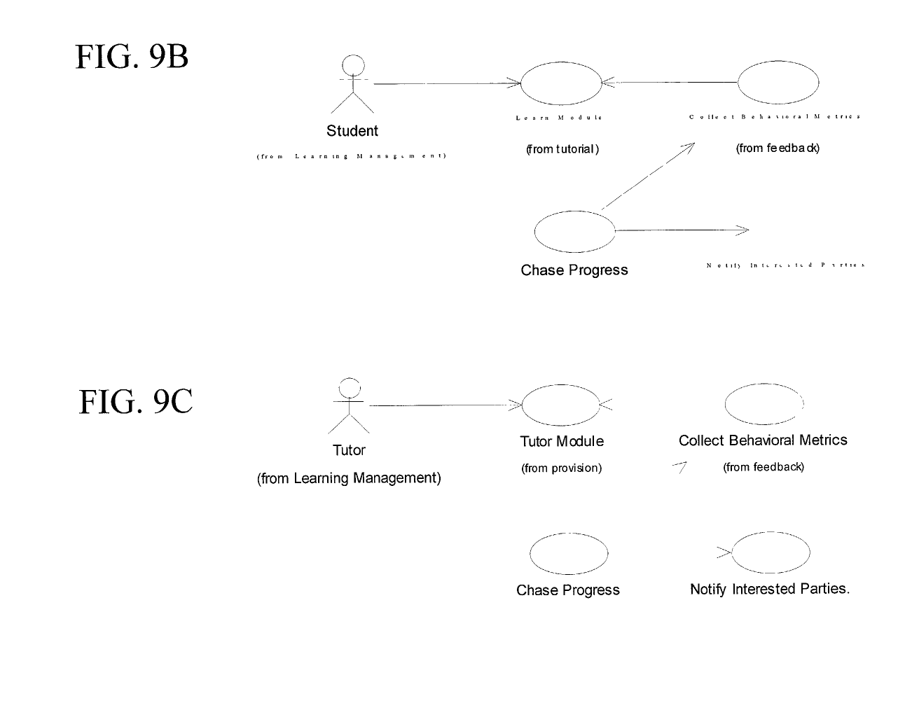

In preferred embodiments, the actor interacts with the e-University to learn a module and to complete the module. Preconditions preferably include that: the actor is enrolled in the module; the actor has the necessary permissions to learn the module; and the actor is logged into the e-University portal. In this regard, with reference to FIG. 9, one or more of the following steps can be carried out in illustrative embodiments:

| | |
|---|---|
| 1 | If a pre-assessment has been defined for the module, the actor |
| | performs a Do Pre-Assessment use case. |
| 2 | A Chase Progress use case is continuously performed while the |
| | actor traverses the module. |
| 3 | The actor continuously performs an Interact with Learning |
| | Material use case as necessary to complete the all units of the |
| | module. |
| 3.1 | If self-assessments have been defined for any units in the |
| | module, the actor performs a Do Self-Assessment use |
| | case. |
| 3.2 | If the actor requires assistance at any point during the |
| | module, she performs a Seek Tutorial Support use case. |
| 3.3 | If the actor is interested in studying additional resources |
| | that are related to the subject matter of the module, she |
| | may perform a Consult Learning Support Resource use |
| | case at any point during the module. |
| 3.4 | If the actor chooses to provide feedback on the module, |
| | she performs a Provide Feedback use case. |
| 3.5 | If the actor chooses to collaborate with others who are |
| | performing a Learn Module use case for the same module, |
| | she performs a Participate in Group Communication use |
| | case. |
| 4 | The actor performs a Do External Assessment use case. |

26. Chase Progress

In preferred embodiments, as a student or tutor performs a Learn Module or a Tutor Module use case, respectively, the system tracks and monitors her progress. The system alerts interested parties when an activity in the module has not been completed successfully. That is, the system can record information about an actor's progress and may, for example, notify interested parties that a learning or tutoring activity in the module has been completed unsuccessfully. Preconditions preferably include that: one or more students are performing the Learn Module use case and/or one or more tutors are performing the Tutor Module use case; and progress-chasing rules have been specified and implemented for the module via a Specify Progress Chasing Rules and Create Progress Chasing Rules use cases, respectively. In this regard, one or more of the following steps can be carried out in illustrative embodiments:

| | |
|---|---|
| 1 | If there are progress-chasing rules defined for the module, the |
| | system monitors all students who are enrolled in the module |
| | while they perform the Learn Module use case, and/or all tutors |
| | who are tutoring the module while they perform the Tutor Module |
| | use case. |
| 2 | If any of the monitored actors fail to successfully learn or tutor an |
| | activity, the system executes a Notify Interested Parties use case. |

For chasing of progress, the applicable methods would depend on the type of interaction conducted and any techniques that are currently known or that are developed may be employed. In some illustrative embodiments, this may be done by rule-based email techniques. Moreover, technologies such as EML and software agents may also be employed. In some preferred embodiments, the design of the system should make use of software agent technology that provides event-driven processes that could monitor the actions of the learners in order to provide context-sensitive tutorial assistance. Additionally, learner support of this form may be built into the design process and could, for example, include the use of text, audio or video responses.

The system can enable, for example, the e-University to track and monitor an individual's learning program, noting existing proficiencies, learning objectives, style, preferred delivery, and more. The system may also be able to monitor an individual's progress over an extended period.

In other embodiments, artificial intelligence algorithms, similar to that used to track and personalise general web interactions, so that users can rely on tools which automatically search for items of interest to them, may be employed in learning and teaching applications.

As a result, for example, the system can enable, among other things, tracking of student activity and/or achievement against these elements using simple processes for course administration and student tracking that make it possible for tutors [e.g., the course team] to define and set up a course with accompanying materials and activities to direct, guide and monitor learner progress.

27. Seek Support

In preferred embodiments, the actor may seek and receive assistance from a tutor or other students while learning a module. Preconditions preferably include that: the actor is performing the Learn Module use case; the actor has the necessary permissions to seek support; the actor is logged into the e-University. In this regard, one or more of the following steps can be carried out in illustrative embodiments:

| | |
|---|---|
| 1 | The actor performs the Interact with e-University use case as |
| | necessary to seek and receive support from the tutor and/or other |
| | students who are also learning the module. Note that the actor |
| | may seek and receive support in a variety of ways. Some |
| | examples may include, but not be limited to: |
| | Conversing one-on-one with the tutor by performing the |
| | Interact via Email use case. |
| | Participating in a tutor's office hours by performing the |
| | Interact via Chatroom, use case. |
| 2 | If the tutor has decided to group the students so that they can |
| | assist each other in learning the module, the actor performs the |
| | Participate in Study Group use case. |
| 3 | If the actor wishes to seek support from individuals who are local |
| | to her, or to attend a local centre that is affiliated with the e- |
| | University, she performs the Seek Local Support use case. |

For seeking of support, a variety of tools can be employed, such as for example, email and computer conferencing. In preferred embodiments, the system will support and/or integrate various synchronous tools (such as, for example, screen-sharing, etc).

In preferred embodiments, the module design (e.g., the learning material itself would be built with a high level of embedded interactive tutorial support, sufficient, as far as possible, to enable learners to use the material with little, if any, further external support.

28. Collect Behavioural Metrics

In preferred embodiments, as a student performs the Learn Module use case, or a tutor performs the Tutor Module use case, the system records usage data, such as login date/time, and interaction statistics. Preconditions preferably include that: one or more actors are performing the Learn Module or Tutor Module use case; the actor is logged into the e-University.

For example, this may help the tutor assess the students and easily identify students who are dropping by the wayside. For example, behavioural metrics may be tracked in some instances based on users entering of names and/or numbers during log-ons and/or message entries.

29. Monitor Student

In preferred embodiments, the actor monitors the progress of students who are learning a module. Preconditions may include that: the actor has been assigned to tutor one or more students who are performing the Learn Module case; the actor has the necessary permissions to monitor the progress of students who are learning a module; the actor is logged into the e-University. In this regard, one or more of the following steps can be carried out in illustrative embodiments:

| | |
|---|---|
| 1 | The actor navigates via the e-University portal to the tutorial |
| | reporting tools, and requests ad-hoc reports on the progress of |
| | one or more students. |
| 2 | If the actor is notified via the Chase Progress use case that is a |
| | student is having difficulty learning a module, she views the |
| | notification and offers support to the student. |

30. Prepare Module

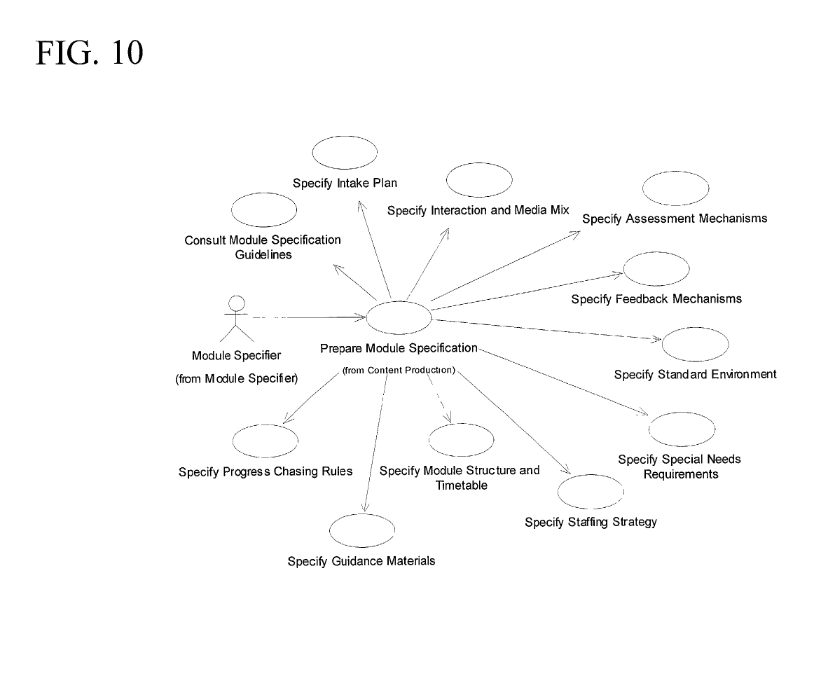

In preferred embodiments, the actor is a module specifier who works, e.g., as a part of a group of technologies and subject matter experts to prepare the specification from which the module will be created. Preconditions preferably include that the actor has the necessary permissions to produce the module specification. In this regard, with reference to FIG. 10, one or more of the following steps can be carried out in illustrative embodiments:

| | |
|---|---|
| 1 | The actor completes standard templates provided by the e- |
| | University to specify and refine the module, and its associated |
| | units, sessions, and learning material. He performs a Consult |
| | Module Specification Guidelines as necessary throughout this |
| | use case. |
| 1.1 | The actor performs a Specify Intake Plan use case. |
| 1.2 | The actor performs a Specify Interaction and Media Mix |
| | use case. |
| 1.3 | The actor performs a Specify Assessment Mechanisms |
| | use case. |
| 1.4 | The actor performs a Specify Feedback Mechanisms use |
| | case. |
| 1.5 | The actor performs a Specify Standard Environment use |
| | case. |
| 1.6 | The actor performs a Specify Special Needs Requirements |
| | use case. |
| 1.7 | The actor performs a Specify Staffing Strategy use case. |
| 1.8 | The actor performs a Specify Module Structure and |
| | Timetable use case. |
| 1.9 | The actor performs a Specify Guidance Materials use |
| | case. |
| 1.10 | The actor performs a Specify Progress Chasing Rules use |
| | case. |

31. Specify Interaction and Media Mix

In preferred embodiments, the actor determines the most optimal combination of interaction mechanisms and media through which a learner should interact with the module. Preconditions may include that the actor, i.e., module specifier, has the necessary permissions to establish the interaction mechanisms. For example, the actor may perform the Consult Specification Guidelines use case, and determine the most optimal combination of interaction mechanisms and media through which a learner should interact with the module.

32. Specify Standard Environment

In preferred embodiments, the actor determines the requirements for the desktop environment of the student who will learn the module and specifies the standard environment. Preconditions preferably include that the actor, i.e., module specifier, has the necessary permissions. For example, the actor determines the minimum desktop environment capabilities, in addition tot he minimum requirements provided by the e-University, which will be necessary to learn the module. Some examples may include, but not be limited to: minimum bandwidth, central processing unit features, memory, software applications required, etc.

33. Specify Chase Progress Rules

In preferred embodiments, the actor specifies the rules that will be used to determine when interested parties should be notified about a student's, or tutor's progress while they perform a Learn Module or a Tutor Module use case. Preconditions preferably include that the actor has the necessary permissions to specify the progress chasing rules. In this regard, one or more of the following steps can be carried out in illustrative embodiments:

| | |
|---|---|
| 1 | The actor specifies events that may occur while a student learns |
| | a module, which may be of interest to certain individuals. Some |
| | examples may include, but not be limited to: |
| | A student missing a due date for an assignment, |
| | A student failing to participate in a scheduled event, such |
| | as a webcast, |
| | A student failing to regularly contribute to a threaded |
| | discussion, etc. |
| 2 | The actor specifies events that may occur while a tutor tutors a |
| | module, which may be of interest to certain individuals. Some |
| | examples may include, but not be limited to: |
| | A tutor failing to log in to the e-University for an extended |
| | period of time. |
| | A tutor failing to participate in a scheduled event, etc. |
| 3 | The actor specifies the email address of interested parties who |
| | need to be informed when a specified event occurs. Some |
| | examples may include, but not be limited to: |
| | A student herself, |
| | A student's tutor, |
| | A student's corporate sponsor, |
| | A tutor's manager, |
| | The e-University Learning Programme Director, etc. |

34. Manage Learning Support Resources

In preferred embodiments, the actor (i.e., an e-University Personnel) secures access to any external digital learning support resources, and distributes any physical resources, which have been specified to supplement a module. Preconditions may include that the actor has the necessary permissions to manage the learning support resources for a module. In this regard, one or more of the following steps can be carried out in illustrative embodiments:

| | |
|---|---|
| 1 | The actor sorts out the contractual and logistical details of |
| | accessing and/or obtaining rights to the learning support |
| | resources that have been specified to supplement the module. |
| 2 | Once a student has been enrolled in a module via an Enroll in |
| | Module use case, the actor secures access to the resources on |
| | the behalf of the individual student. |
| 2.1 | If external digital library resources have been specified, the |
| | actor performs a Secure Access to External Digital Library |
| | use case. |
| 2.2 | If physical resources have been specified, the actor |
| | performs a Distribute Physical Resource use case. |

35. Data Integration

In environments such as an e-University that may provide electronic teaching resources for a plurality of institutions, a system preferably supports a variety of hybrid data integration models between the e-University and such institutions. In addition to hybrid integration models, the e-University may need to share data interfaces with institutions (e.g., to upload tutor information or the like). In some instances, the may be automatic feeds through systems and in other a more manual approach of, e.g., producing flat file formats for manual upload or even manual data entry. The system design is preferably flexible enough to implement a variety of physical interfaces and processes for data interchange.

36. Illustrative System Implementation

In some illustrative and non-limiting embodiments, a Sun Open Net Environment (SunONE™) can be employed. SunONE is Sun Microsystems™′ vision, architecture, platform and expertise for creating, deploying and delivering smart web services. SunONE includes an open architecture framework and utilizes standard body protocols such as HTTP and XML web services that are web-accessible by HTTP and other web protocols. Interfaces to web services, i.e. inputs to and outputs from the service, can be exposed and described using the web Services Description Language (WSDL) and can be represented in XML format. Communication and message exchange between web services can be encapsulated in Simple Object Access Protocol (SOAP). Web services can be discovered and located through a web service registry such as the Universal Discovery Description Interface (UDDI).

In preferred embodiments, such as in the e-University environment or the like, web services can be made available to partner institutions. The SunONE open framework enables reuse of services, standardises message exchange and empowers application and system interoperability. In addition, a unified service registry can lower development cost by minimising languages and development environments while maximising the range of web services platforms. With a SunONE framework, the e-University Learning Environment or the like can, e.g., utilise existing resources and services offered by University Libraries, University Student Registration and Administrations, while at the same time providing services such as assessment, and content authoring to its partners.

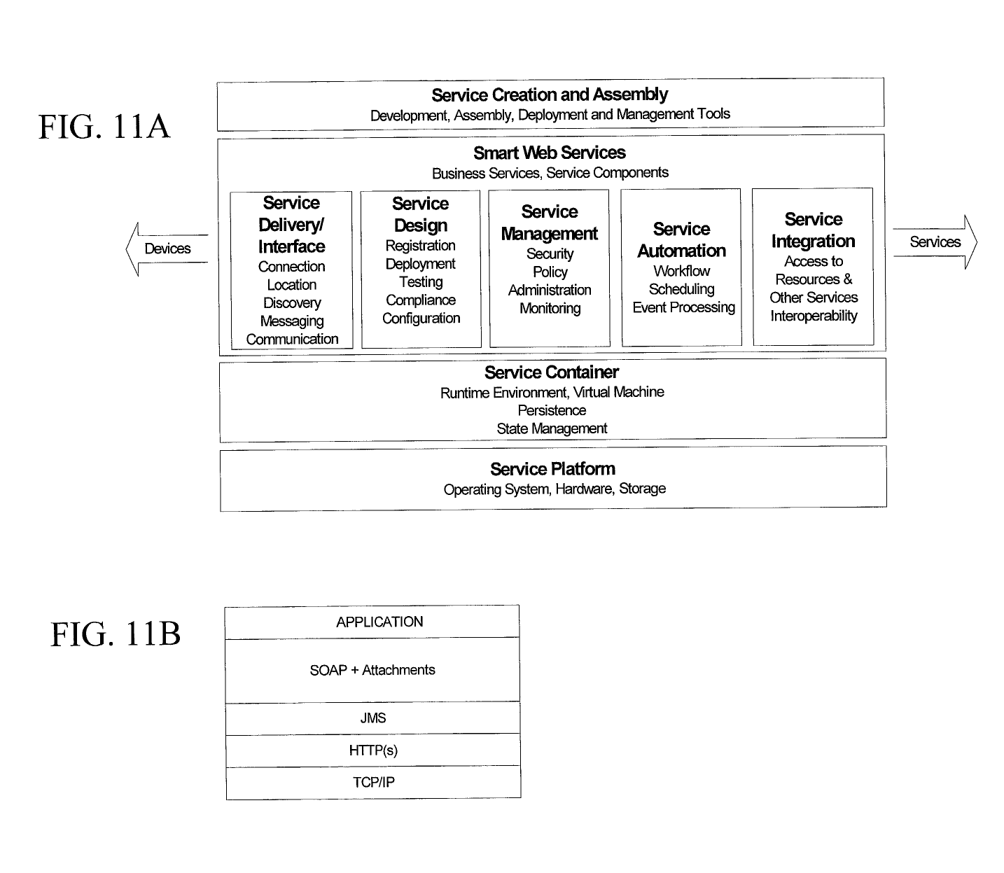

FIG. 11A shows a layered view of an illustrative SunONE architecture. The architecture is composed of four major components. A platform and set of tools to assemble and develop web services, web services and their capabilities as service offerings, an environment capable of running the web services, and platforms for hosting and supporting web services. The Service Creation and Assembly Platform is an interactive development platform. It contains a collection of tools and utilities that, in combination with Service Management and Service Design components of the Smart Web Service layer, enable designers, developers, integrators and architects to design, create, assemble, deploy and manage web services. FORTE FOR JAVA is an illustrative example of such a platform. The Smart Web Services layer of the Sun ONE architecture is composed of three sub-layers of services that inter-operate to facilitate all service development and delivery operations. These Smart Web Service Groupings include: Core Services (the base services necessary to support any Smart Web services usage scenario); Business-Neutral Services (a set of commonly utilised services that support many different business-specific service scenarios); and Business-Specific Services (any service or combination of services that delivers measurable value to a business entity or its constituents). The Service Container is a run-time environment for running web services. It provides session, state and persistence management. An application server or a web container is an example of a Service Container. The Service Platform is the hardware platform, the operating systems and the storage arrays in hosting and supporting the Web services. Examples of Service Platform include SUN E4500, SOLARIS OPERATING SYSTEM and ORACLE PARALLEL SERVER.

FIG. 11B illustrates SunONE services technology protocols. Web services include coarse-grain software components that perform specific tasks. Applications include one or more web services. Legacy applications that have exposed XML interfaces, are accessible over web protocols, and are locatable in a service registry are web services. Communications between web services as well as between web services and web service registries will include an application making API calls using the Simple Object Access Protocol (SOAP). SOAP provides a lightweight protocol for exchange of information in a decentralized, distributed environment. This exchange of information can be modeled as either a message or a remote procedure call (RPC). SOAP may sit upon a JAVA MESSAGE SYSTEM (JMS) compliant product to support guaranteed messaging. If a JMS compliant transport mechanism is used, it will use HTTP as its carrier. SOAP implementations with bindings to JMS compliant products is an emergent implementation, this protocol stack depicts a long-range view.

37. Single Sign-On

In some preferred embodiments, the system, e.g., the e-University portal system or the like, will aggregate applications and products from multiple vendors to offer the best of breed solution-sets. However, vendors may often have their own authentication mechanisms. To avoid users logging into multiple systems and administrators maintaining multiple sets of user password credentials, in preferred embodiments, a single sign-on implementation will be employed.

For example, with single sign-on, a user requests an application resource from a server, the server collects the access-control list (ACL) associated with that resource and evaluates them. If the server's evaluation of the ACL requires identification of the user, the server requests client authentication, in the form of either a name and password or a digital certificate presented according to the Secure Socket Layers protocol. Upon successful authentication, the server establishes an active user session and propagates the session information and user credentials to the requested application system. The active user session is maintained so that when the user requests resources from a different application system, the user session and credentials can simply be sent along.

38. Remote Log-In

In preferred embodiments, a remote login is provided that allows users, via a web browser, to connect to a e-University portal or the like. It preferably permits authorized users to access the portal resources from home or on the road.

An illustrative implementation for remote access is via a proxy server. The proxy server sits between the client browsers and the e-University portal, and acts as a security service. It intercepts all remote requests for the portal system, authenticates users, and only directs the authorized requests to the portal server. An example of remote login is access to email. From the browser, a user connects to the portal proxy server and enters username and password. The proxy server authenticates the user, upon validation, requests the portal resources home page and passes it back to the user. The user next selects the email URL, configures its mail client, via the proxy, and downloads mail messages from the mail server. The mail server preferably supports multiple email delivery protocols such as IMAP and POP. To read email, users can choose from a variety of mailers, from browser-based thin client to feature-rich thick client such as Eudora and Microsoft Outlook.

Broad Scope of the Invention

While illustrative embodiments of the invention have been described herein, it will be appreciated that the present invention is not limited to the various embodiments described herein, but includes any and all embodiments having modifications, omissions, combinations (e.g., of aspects across various embodiments), adaptations and/or alterations as would be appreciated by those in the art based on the present disclosure. The appended claims are to be interpreted broadly based the language employed in the claims and not improperly limited to illustrative examples described in the present specification or in the prosecution of the application. As merely one example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts are not recited in support of that function.

What is claimed is:

1. An online interaction system, comprising:
a) means for selecting at least one mechanism of communication from a plurality of mechanisms of communication for a first set of system users;
b) means for selecting at least one mechanism of communication from said plurality of mechanisms of communication for a second set of system users;
c) permissioning means for limiting at least some interactions of said first set of system users to users within the first set of users; and
d) permissioning means for limiting at least some interactions of said second set of system users to users within the second set of users.

2. The online interaction system of claim 1, further including means for enabling users from the first and/or second set of system users to select from a plurality of mechanisms of communication for a given interaction.

3. The online interaction system of claim 1, further including record history means for tracking and/or chasing user communications to provide a record and/or history of such communications.

4. The online interaction system of claim 1, wherein said system is an electronic university system.

5. The online interaction system of claim 1, further including basic-format means for obtaining data related to a plurality, and preferably all, of each of the following basic formats: animation; audio; graphics; text; and/or video, and wherein at least some of said mechanisms of communication include means to receive data from one or more of said plurality of basic-format means.

6. A method for managing online interaction via an electronic computer system, comprising:
a) selecting by an administrator at least one mechanism of communication from a plurality of mechanisms of communication for a first set of system users;
b) selecting by another administrator at least one mechanism of communication from said plurality of mechanisms of communication for a second set of system users;
c) limiting at least some interactions of said first set of system users to users within the first set of users based on user permissioning; and
d) limiting at least some interactions of said second set of system users to users within the second set of users based on user permissioning.

7. The method of claim 6, further including having users from the first and/or second set of system users select from a plurality of mechanisms of communication for a given interaction.

8. The method of claim 6, further including tracking and/or chasing user communications to provide a record and/or history of such communications.

9. The method of claim 6, further including managing online electronic university interactions and having said system as an electronic university portal.
